(19) United States
(12) Patent Application Publication
(10) Pub. No.: US 2026/0135459 A1
(43) Pub. Date: May 14, 2026

(54) POWER CONVERSION DEVICE

(71) Applicant: LITE-ON TECHNOLOGY CORPORATION, Taipei (TW)

(72) Inventor: Chih-Shan CHEN, Taipei (TW)

(21) Appl. No.: 19/011,667

(22) Filed: Jan. 7, 2025

(30) Foreign Application Priority Data
Nov. 8, 2024 (CN) 202411592069.8

(51) Int. Cl. H02M 1/00; H02M 1/32; H02M 1/42; H02M 3/00; H02M 7/5395

(52) U.S. Cl. CPC H02M 1/0019; H02M 1/0012; H02M 1/0058; H02M 1/327; H02M 3/01; H02M 7/5395; H02M 1/4208

(57) ABSTRACT

A power conversion device, comprises at least a voltage converter, a resonant converter, a feedback circuit, an output circuit and a control gain circuit. The voltage converter receives an input differential voltage, and converts the input differential voltage into a first relay voltage. The resonant converter converts the first relay voltage into a second relay voltage. The feedback circuit is coupled to the resonant converter through a feedback path. The output circuit generates an output voltage based on an output differential voltage. The control gain circuit executes a control mechanism to adjust the first relay voltage and the output voltage. A total voltage gain of the power conversion device is associated with a first ratio value between the output voltage and an input voltage, and the control gain circuit adjusts the total voltage gain according to the control mechanism.

This application claims the benefit of PRC application serial No. 202411592069.8, filed Nov. 8, 2024, the disclosure of which is incorporated by reference herein in its entirety.

### TECHNICAL FIELD

The present disclosure relates to a power conversion device, and in particular, relates to a power conversion device capable of adjusting the output voltage and the total voltage gain.

### BACKGROUND

Power system plays an indispensable key role in the development of emerging energy sources. Among various components of the power system, a power conversion device takes the most important position. The Power conversion device often includes a resonant converter, and the resonant converter can be implemented by an inductor-inductor-capacitor (LLC) converter.

In existing technologies, the inductor-inductor-capacitor converter used in the power conversion device is usually applied to a fixed output voltage. Hence, the power conversion device cannot change its output voltage in response to different operating conditions (such as, different load conditions) thereby altering the total voltage gain. In other words, the power conversion device cannot change the output voltage and therefore lacks flexibility in application.

In view of the above issues, an improved power conversion device is needed, which can adjust the output voltage and total voltage gain in response to different load conditions.

### SUMMARY

According to an embodiment of the present disclosure, a power conversion device is provided. The power conversion device comprises the following elements. A voltage converter, is for receiving an input differential voltage, wherein the input differential voltage is associated with an input voltage of the power conversion device, and the voltage converter converts the input differential voltage into a first relay voltage. A resonant converter, is for converting the first relay voltage into a second relay voltage. A feedback circuit, receiving an output differential voltage, wherein the output differential voltage is indirectly associated with the second relay voltage, and the feedback circuit is coupled to the resonant converter through a feedback path. An output circuit, is for generating an output voltage of the power conversion device according to the output differential voltage. A control gain circuit, executing a control mechanism to adjust the first relay voltage and the output voltage. The power conversion device has a total voltage gain, the total voltage gain is associated with a first ratio value of the output voltage and the input voltage, and the control gain circuit adjusts the total voltage gain according to the control mechanism.

### BRIEF DESCRIPTION OF THE DRAWINGS

FIG. 1 is a circuit diagram of a power conversion device 1000 according to an embodiment of the present disclosure.

FIGS. 2A to 2D are schematic diagrams of different embodiments for the voltage control gain circuit 600 of FIG. 1 executing a control mechanism to adjust the first relay voltage Vb and the output voltage Vo.

FIG. 3A is a circuit diagram of a power conversion device 1000b according to another embodiment of the present disclosure.

FIG. 3B is a circuit diagram of a power conversion device 1000c according to yet another embodiment of the present disclosure.

FIG. 4 is a circuit diagram of a power conversion device 1010 according to yet another embodiment of the present disclosure.

FIGS. 5A-1 to 5D-2 are schematic diagrams of various embodiments for the current control gain circuit 610 of FIG. 4 executing a control mechanism to adjust the first relay voltage Vb.

FIG. 6 is a circuit diagram of a power conversion device 1010b according to further another embodiment of the present disclosure.

FIG. 7 is a schematic diagram of a lookup table which is referenced by the current control gain circuit 610 of FIG. 6.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

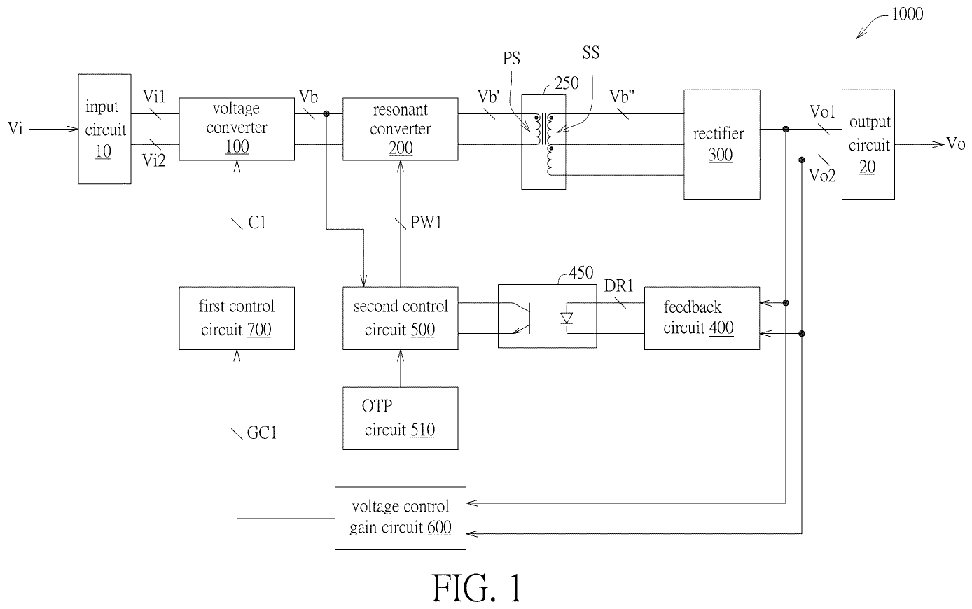

FIG. 1 is a circuit diagram of a power conversion device 1000 according to an embodiment of the present disclosure. As shown in FIG. 1, the power conversion device 1000 includes an input circuit 10, a voltage converter 100, a resonant converter 200, a transformer 250, a rectifier 300, an output circuit 20, a feedback circuit 400, a coupling circuit 450, a second control circuit 500, an over-temperature protection (OTP) circuit 510, a voltage control gain circuit 600 and a first control circuit 700.

The input circuit 10 receives an input voltage Vi from a voltage source (not shown in FIG. 1), and the input voltage Vi can be a DC voltage or an AC voltage. In addition, the input circuit 10 generates input differential voltages (Vi1, Vi2) based on the input voltage Vi.

The voltage converter 100 performs voltage conversion on the input differential voltage (Vi1, Vi2). One single-ended voltage Vi2 of the input differential voltage (Vi1, Vi2) is equal to a ground potential, and the other single-ended voltage Vi1 of the input differential voltage (Vi1, Vi2) is converted into a first relay voltage Vb by the voltage converter 100. In an example, the voltage converter 100 may perform a power factor correction (PFC) on the input differential voltage (Vi1, Vi2) to optimize the voltage waveform and improve efficiency. In another example, the voltage converter 100 is a buck converter or a boost converter which performs a boost operation or a buck operation on the input differential voltage (Vi1, Vi2).

The resonant converter 200 receives the first relay voltage Vb generated by the voltage converter 100, and performs DC-DC conversion on the first relay voltage Vb to obtain the second relay voltage Vb′. In one example, the resonant converter 200 is, for example, an inductor-inductor-capacitor (LLC) converter, which uses resonant technology to perform a “soft switch mechanism” to reduce switching losses and can be applied to power conversion of high efficiency/high power density. Furthermore, the gain of the resonant converter 200 can be changed in response to the first relay voltage Vb; that is, the first relay voltage Vb can be adjusted by the voltage converter 100, thereby changing the gain of the resonant converter 200.

The primary side PS of the transformer 250 is coupled to the resonant converter 200. The transformer 250 further boosts or bucks the second relay voltage Vb′ generated by the resonant converter 200, to obtain a third relay voltage Vb″.

Furthermore, the secondary side SS of the transformer 250 is coupled to the rectifier 300. The rectifier 300 rectifies the third relay voltage Vb″ generated by the transformer 250 into a stable DC voltage, thereby generating an output differential voltage (Vo1, Vo2). In one example, the rectifier 300 is, for example, a diode rectifier. In another example, the rectifier 300 is, for example, a synchronous rectifier. The rectification effect of the synchronous rectifier is better than that of the diode rectifier.

The output circuit 20 receives the output differential voltage (Vo1, Vo2) from the rectifier 300 and generates the output voltage Vo according to the output differential voltage (Vo1, Vo2). The output voltage Vo is provided to the load. On the other hand, the output differential voltages (Vo1, Vo2) are also sent to the feedback circuit 400.

The feedback circuit 400 can serve as a starting point of one of the feedback paths of the power conversion device 1000. The feedback path is as follows: the feedback circuit 400 is coupled to the output end of the rectifier 300 to receive the output differential voltages (Vo1, Vo2), and the feedback circuit 400 is coupled to the resonant converter 200 via the coupling circuit 450 and the second control circuit 500. Through the feedback path associated with the feedback circuit 400, the output differential voltages (Vo1, Vo2) can be kept stable.

More specifically, the feedback circuit 400 monitors the output differential voltages (Vo1, Vo2) to generate a monitoring result DR1. Furthermore, via the above-mentioned feedback path, the feedback circuit 400 feeds back the monitoring result DR1 to the second control circuit 500 via the coupling circuit 450. On the other hand, the second control circuit 500 receives the first relay voltage Vb generated by the voltage converter 100. The second control circuit 500 generates the pulse width modulation (PWM) signal PW1 according to the monitoring result DR1 and the first relay voltage Vb. Furthermore, the second control circuit 500 controls the resonant converter 200 to perform conversion of the first relay voltage Vb based on the PWM signal PW1, thereby adjusting the corresponding second relay voltage Vb′. In other words, through the feedback path associated with the feedback circuit 400, the second relay voltage Vb′ can be adjusted in response to the present output differential voltage (Vo1, Vo2).

In an example, an over-current protection (OCP) circuit and/or an over-voltage protection (OVP) circuit may be provided inside the second control circuit 500 to perform over-current protection and/or over-voltage protection (the OCP circuit and OVP circuit are not shown in FIG. 1). In addition, an over-temperature protection (OTP) circuit 510 is provided outside the second control circuit 500; the second control circuit 500 is coupled to the OTP circuit 510 to perform over-temperature protection.

The output differential voltages (Vo1, Vo2) generated by the rectifier 300 are fed back to the feedback circuit 400. In addition, the output differential voltages (Vo1, Vo2) are also fed back to the voltage control gain circuit 600. In response to the present load condition of the power conversion device 1000, the voltage control gain circuit 600 monitors the present output differential voltage (Vo1, Vo2) of the power conversion device 1000 and generates the gain control signal GC1 according to the current output differential voltage (Vo1, Vo2), and transmits the gain control signal GC1 to the first control circuit 700. The first control circuit 700 generates a control signal C1 according to the gain control signal GC1, thereby controlling the voltage converter 100 to adjust the first relay voltage Vb. Then, the second control circuit 500 monitors the first relay voltage Vb which has been adjusted, and further adjusts the PWM signal PW1 according to the adjusted first relay voltage Vb, thereby adjusting the operation of the resonant converter 200. The resonant converter 200 adjusts the second relay voltage Vb′ generated by the resonant converter 200 according to the PWM signal PW1 which has been adjusted, such that subsequent output differential voltages (Vo1, Vo2) and the output voltage Vo will be adjusted.

The voltage control gain circuit 600 monitors the output differential voltage (Vo1, Vo2) of the power conversion device 1000 under different load conditions, and adjusts the output differential voltage (Vo1, Vo2) in response to different load conditions, and then finely adjusts the output voltage Vo. Accordingly, the output voltage Vo can be ensured to meet specifications required by a user, under different load conditions of the power conversion device 1000, and the efficiency and stability of the power conversion device 1000 can be optimized.

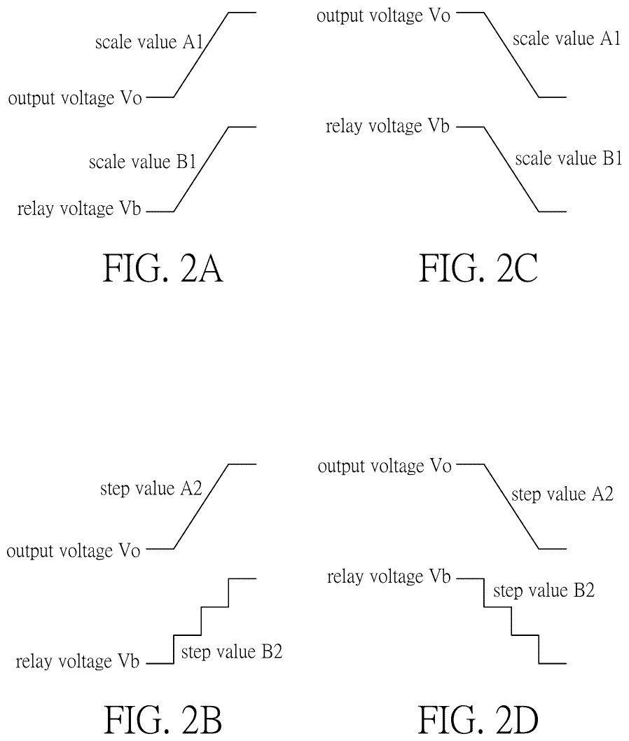

FIGS. 2A to 2D are schematic diagrams of different embodiments for the voltage control gain circuit 600 of FIG. 1 executing a control mechanism to adjust the first relay voltage Vb and the output voltage Vo. Please refer to FIG. 2A first, the voltage control gain circuit 600 executes a control mechanism according to a multiplication operation to adjust the first relay voltage Vb and the output voltage Vo, so that the first relay voltage Vb is multiplied by a scaling value B1 and amplified as a voltage value “Vb×B1”, and the output voltage Vo is multiplied by a scaling value A1 and amplified as a voltage value “Vo×A1”.

In operation, the voltage controlled gain circuit 600 provides the gain control signal GC1 to the first control circuit 700. In response to the gain control signal GC1, the first control circuit 700 simulates the multiplication operation for the first relay voltage Vb. The first control circuit 700 provides the control signal C1 corresponding to the multiplication operation to the voltage converter 100, causing the voltage converter 100 to adjust the first relay voltage Vb as: the first relay voltage Vb is multiplied by the scaling value B1.

On the other hand, the second control circuit 500 monitors the first relay voltage Vb which has been adjusted, and the second control circuit 500 attempts to simulate the multiplication operation of the second relay voltage Vb′. The second control circuit 500 provides the PWM signal PW1 corresponding to the multiplication operation to the resonant converter 200, causing the resonant converter 200 to adjust the second relay voltage Vb′ as: the second relay voltage Vb′ is multiplied by the scaling value A1. In response to the multiplication operation of the second relay voltage Vb′, the subsequent output voltage Vo is also adjusted as: the output voltage Vo is multiplied by the scaling value A1.

According to the above embodiment, the voltage control gain circuit 600 executes a control mechanism according to the multiplication operation, so that the first control circuit 700 simulates the multiplication operation of the first relay voltage Vb (multiplying the first relay voltage Vb by the scaling value B1), and the second control circuit 500 simulates the multiplication operation of the second relay voltage Vb′ (multiplying the second relay voltage Vb′ by the scaling value A1), thereby multiplying the output voltage Vo by the scaling value A1. Accordingly, the total voltage gain G of the power conversion device 1000 is shown in equation (1-1):

$$G = \frac{Vo \times A 1}{Vi \times B 1} = \frac{Vo \times A 1}{( \frac{V b}{2} ) \times B 1} \qquad ( 1 - 1 )$$

As shown in equation (1-1), the total voltage gain G is related to the first ratio value RT1 between the output voltage Vo and the input voltage Vi; the first ratio value RT1 is a quotient of the output voltage Vo divided by the input voltage Vi. In various examples, the scaling value A1 can be set to be greater than, equal to, or smaller than the scaling value B1, so as to adjust the value of the total voltage gain G accordingly.

Next, please refer to FIG. 2B, the voltage control gain circuit 600 executes a control mechanism according to an addition operation, so as to adjust the first relay voltage Vb and the output voltage Vo. The voltage control gain circuit 600 provides the gain control signal GC1 to the first control circuit 700, causing the first control circuit 700 to simulate the addition operation of the first relay voltage Vb. The first control circuit 700 provides the control signal C1 corresponding to the addition operation to the voltage converter 100, causing the voltage converter 100 to adjust the first relay voltage Vb as: the first relay voltage Vb is added by n's step value B2. Wherein, the number n is a positive integer (n=1, 2, 3, 4, etc.).

On the other hand, in response to the first relay voltage Vb which has been adjusted, the second control circuit 500 simulates the addition of the second relay voltage Vb′. The second control circuit 500 provides the PWM signal PW1 corresponding to the addition operation to the resonant converter 200, causing the resonant converter 200 to add the second relay voltage Vb′ by a predetermined value. Moreover, corresponding to the addition operation of the second relay voltage Vb′, the subsequent addition of the output voltage Vo is equivalently performed as: the output voltage Vo is added by the step value A2.

According to the above embodiment, the voltage control gain circuit 600 executes a control mechanism according to the addition operation, causing the first control circuit 700 to simulate the addition operation of the first relay voltage Vb, and increase the first relay voltage Vb as the voltage value “Vb+(B2×n)” by adding n's step value B2. Furthermore, the second control circuit 500 simulates the addition operation of the second relay voltage Vb′, and then performs the addition operation of the output voltage Vo equivalently, adding the output voltage Vo by the step value A2 to form a voltage value “Vo+A2”. Accordingly, the total voltage gain G of the power conversion device 1000 is shown in equation (1-2a):

$$G = \frac{V o + A 2}{V i + ( B 2 \times n )} = \frac{V o + A 2}{( \frac{V b}{2} ) + ( B 2 \times n )} \qquad ( 1 - 2 a )$$

In another example, the addition operation of the output voltage Vo can be further adjusted, so that the output voltage Vo is added by n's step value A2 and increased as the voltage value “Vo+(A2×n)”. Accordingly, the total voltage gain G of the power conversion device 1000 can be adjusted as equation (1-2b):

$$G = \frac{V o + ( A 2 \times n )}{V i + ( B 2 \times n )} = \frac{V o + ( A 2 \times n )}{( \frac{V b}{2} ) + ( B 2 \times n )} \qquad ( 1 - 2 b )$$

In formula (1-2b), when the values of step A2 and step B2 are small and the value of number n of steps is large, the effect of the addition operation of the output voltage Vo and the first relay voltage Vb is similar to the multiplication operation in the embodiment of FIG. 2A.

Next, please refer to FIG. 2C, the voltage control gain circuit 600 executes a control mechanism according to a division operation to adjust the first relay voltage Vb and the output voltage Vo. The voltage control gain circuit 600 generates the gain control signal GC1 corresponding to the division operation. The first control circuit 700 simulates a division operation of the first relay voltage Vb in response to the gain control signal GC1, so as to control the voltage converter 100 to divide the first relay voltage Vb by the scaling value B1 and reduce it to a voltage value “Vb/B1”. Furthermore, the second control circuit 500 simulates the division operation of the second relay voltage Vb′ in response to the first relay voltage Vb which has been adjusted, so as to control the resonant converter 200 to divide the second relay voltage Vb′ by the scaling value A1. Then, the output voltage Vo is divided by the scaling value A1 and reduced to the voltage value “Vo/A1”. Accordingly, the total voltage gain G of the power conversion device 1000 is shown in equation (1-3):

$$G = \frac{Vo / A 1}{Vi / B 1} = \frac{Vo / A 1}{( \frac{V b}{2} ) / B 1} \qquad ( 1 - 3 )$$

Next, please refer to FIG. 2D, the voltage control gain circuit 600 executes a control mechanism according to a subtraction operation to adjust the first relay voltage Vb and the output voltage Vo. The voltage control gain circuit 600 generates the gain control signal GC1 corresponding to the subtraction operation. The first control circuit 700 simulates the subtraction operation of the first relay voltage Vb in response to the gain control signal GC1 to control the voltage converter 100 to subtract n's step value B2 from the first relay voltage Vb, so as to obtain a voltage value “Vb−(B2×n)”. Furthermore, the second control circuit 500 simulates the subtraction operation of the second relay voltage Vb′ in response to the first relay voltage Vb which has been adjusted, and then equivalently performs the subtraction operation of the output voltage Vo, so that the output voltage Vo is subtracted by the step value A2 and becomes the voltage value “Vo−A2”. According to this, the total voltage gain G of the power conversion device 1000 is shown in equation (1-4a):

$$G = \frac{V o - A 2}{V i - ( B 2 \times n )} = \frac{V o - A 2}{( \frac{V b}{2} ) - ( B 2 \times n )} \qquad ( 1 - 4 a )$$

In another example, the subtraction operation of the output voltage Vo can be further adjusted, such that the output voltage Vo is subtracted by n's step A2 and becomes the voltage value “Vb−(A2×n)”. Accordingly, the total voltage gain G of the power conversion device 1000 is adjusted as equation (1-4b):

$$G = \frac{V o - ( A 2 \times n )}{V i - ( B 2 \times n )} = \frac{V o - ( A 2 \times n )}{( \frac{V b}{2} ) - ( B 2 \times n )} \qquad ( 1 - 4 b )$$

In equation (1-4b), when the values of step A2 and step B2 are small and the value of number n of steps is large, the effect of the subtraction operation between the output voltage Vo and the first relay voltage Vb is similar to the division operation in the embodiment of FIG. 2C.

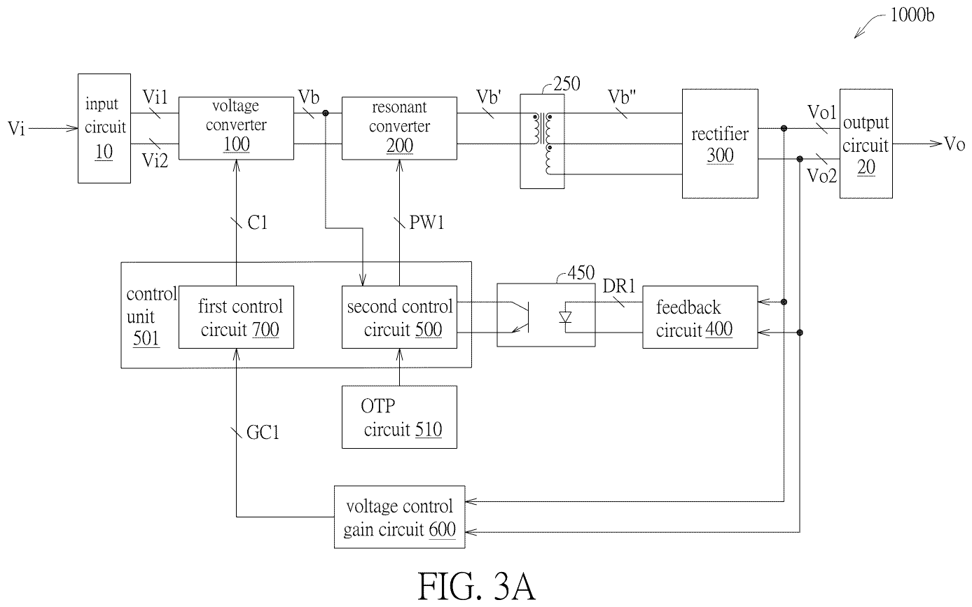

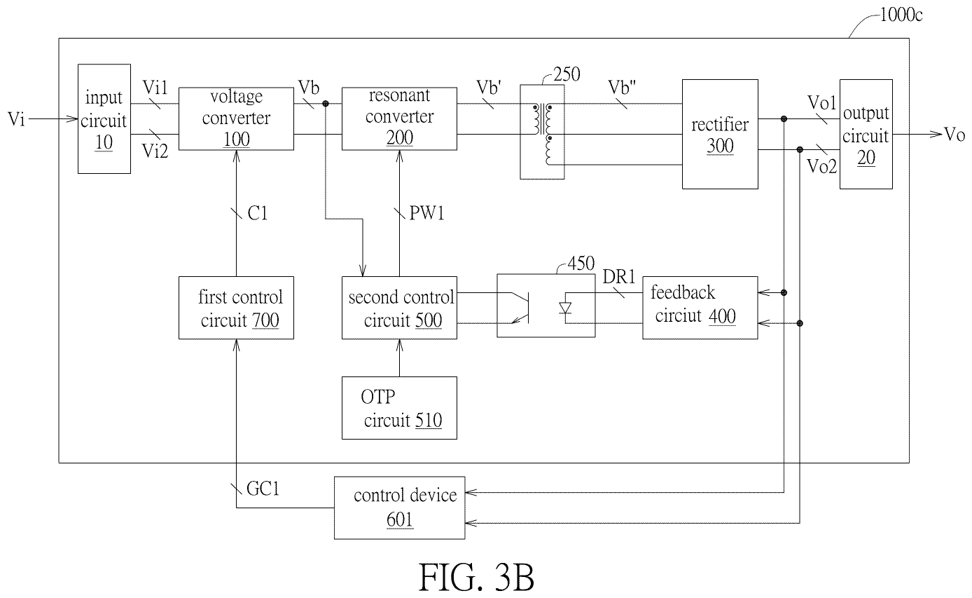

FIG. 3A is a circuit diagram of a power conversion device 1000b according to another embodiment of the present disclosure. The first control circuit 700 and the second control circuit 500 of the power conversion device 1000b of the embodiment of FIG. 3A are integrated into a single control unit 501; where the control unit 501 is, for example, a “combo chip”.

FIG. 3B is a circuit diagram of a power conversion device 1000c according to yet another embodiment of the present disclosure. The power conversion device 1000c in the embodiment of FIG. 3B monitors the present output differential voltage (Vo1, Vo2) through an external control device 601 and generates the gain control signal GC1, so as to perform the control mechanism for operations of multiplication/addition/division/subtraction and thereby adjust the first relay voltage Vb and the output voltage Vo. The control device 601 is, for example, an external computing device independent of the power conversion device 1000c, which may include: a personal computer, a server or a mobile device.

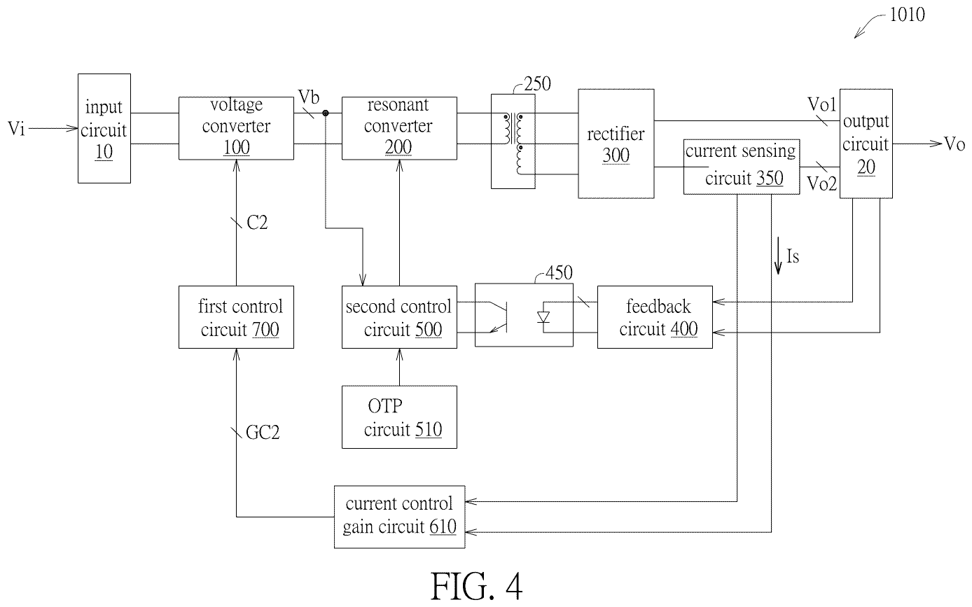

FIG. 4 is a circuit diagram of a power conversion device 1010 according to yet another embodiment of the present disclosure. The circuit structure of the power conversion device 1010 in FIG. 4 is similar to the power conversion device 1000 in FIG. 1. The power conversion device 1010 in FIG. 4 also includes an input circuit 10, a voltage converter 100, a resonant converter 200, a transformer 250, and a rectifier 300, an output circuit 20, a feedback circuit 400, a coupling circuit 450, a second control circuit 500, an over-temperature protection circuit 510 and a first control circuit 700.

Different from the voltage control gain circuit 600 of the power conversion device 1000 in FIG. 1, the power conversion device 1010 in FIG. 4 is provided with a current control gain circuit 610. Furthermore, the power conversion device 1010 in FIG. 4 is further provided with a current sensing circuit 350 between the rectifier 300 and the output circuit 20. In addition, in the operation mechanism, the voltage control gain circuit 600 of the power conversion device 1000 in FIG. 1 executes a control mechanism based on the output differential voltages (Vo1, Vo2) of different load conditions, thereby adjusting the first relay voltage Vb and output voltage Vo. Different from the voltage control gain circuit 600 of the power conversion device 1000, the current control gain circuit 610 of the power conversion device 1010 in FIG. 4 executes a control mechanism according to the sensed current Is of different load conditions. The sensing current Is was generated by the current sensing circuit 350. For example, a resistive element is provided inside the current sensing circuit 350, and the resistive element generates the sensing current Is according to one single-ended voltage Vo2 of the output differential voltages (Vo1, Vo2). The current sensing circuit 350 is disposed at the output end of the power conversion device 1010 (that is, the current sensing circuit 350 is disposed adjacent to the output circuit 20). Therefore, the sensing current Is generated by the current sensing circuit 350 can represent the output load of the power conversion device 1010.

The current control gain circuit 610 monitors the sensing current Is generated by the current sensing circuit 350. Since the sensing current Is may represent the output load of the power conversion device 1010, the current control gain circuit 610 may analyze changes in the output load of the power conversion device 1010 according to the sensed current Is.

Furthermore, the current control gain circuit 610 generates the corresponding gain control signal GC2 according to the change of the output load, thereby executing the corresponding control mechanism to adjust the first relay voltage Vb outputted by the voltage converter 100, thereby adjusting the total voltage gain G of the power conversion device 1010.

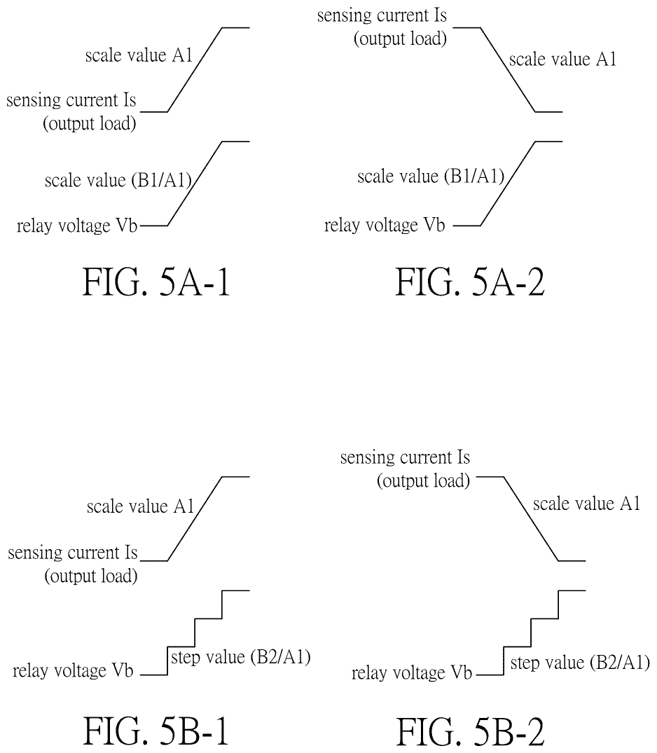

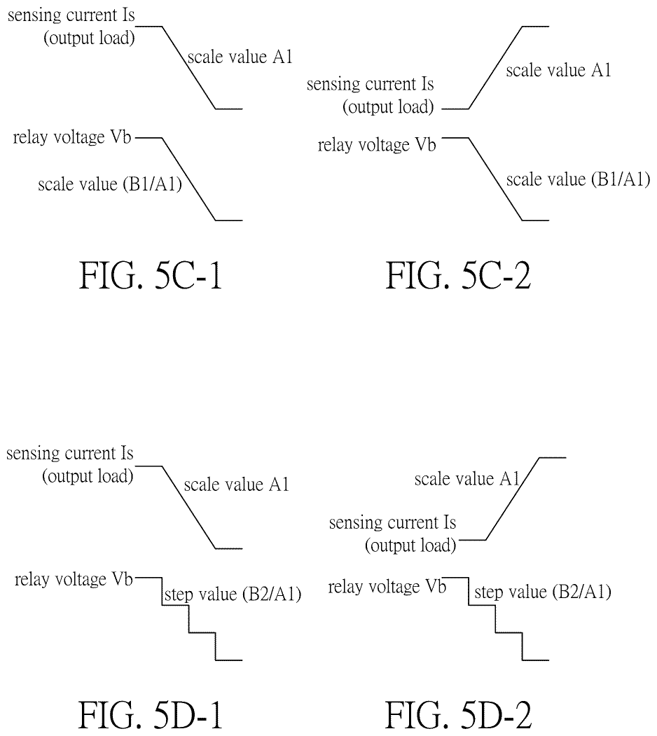

FIGS. 5A-1 to 5D-2 are schematic diagrams of various embodiments for the current control gain circuit 610 of FIG. 4 executing a control mechanism to adjust the first relay voltage Vb. Please refer to FIG. 5A-1 first, the current control gain circuit 610 analyzes changes in the output load of the power conversion device 1010 according to the sensing current Is. The sensing current Is increases with the scaling value A1, indicating that the output load of the power conversion device 1010 increases with the scaling value A1. In response to the above changes in the output load, the current control gain circuit 610 provides the corresponding gain control signal GC2 to the first control circuit 700, causing the first control circuit 700 to simulate the multiplication operation of the first relay voltage Vb, thereby controlling the voltage converter 100 to adjust the first relay voltage Vb by multiplying the first relay voltage Vb with the scaling value (B1/A1). Wherein, the scaling value (B1/A1) is substantially equal to a second ratio value RT2 between the scaling value B1 and the scaling value A1. Wherein, the second ratio value RT2 is a quotient of the scaling value B1 divided by the scaling value A1.

According to the above embodiment, in response to the output load increasing with the scaling value A1, the current control gain circuit 610 performs a multiplication control mechanism to multiply the first relay voltage Vb by the scaling value (B1/A1), and then the total voltage gain G of the power conversion device 1000 is adjusted as equation (2-1). The output load of the power conversion device 1010 increases by the scaling value A1, and the first relay voltage Vb increases by the scaling value (B1/A1), and the total voltage gain G decreases.

$$G = \frac{V o}{V i \times \frac{B 1}{A 1}} = \frac{V o}{( \frac{V b}{2} ) \times \frac{B 1}{A 1}} \qquad ( 2 - 1 )$$

On the other hand, please refer to FIG. 5A-2, the implementation condition is changed as: the sensing current Is decreases by the scaling value A1, which means that the output load of the power conversion device 1010 decreases by the scaling value A1. The first control circuit 700 simulates the multiplication operation of the first relay voltage Vb, so that the first relay voltage Vb increases with the scaling value (B1/A1). The total voltage gain G of the power conversion device 1000 is still as equation (2-1), and the total voltage gain G decreases.

Next, see FIG. 5B-1. The implementation conditions of FIG. 5B-1 are similar to the embodiment of FIG. 5A-1: the sensing current Is increases with a scaling value A1, which means that the output load of the power conversion device 1010 increases with the scaling value A1. Different from the simulated multiplication operation of the embodiment of FIG. 5A-1, the embodiment of FIG. 5B-1 simulates the addition operation of the first relay voltage Vb executed by the first control circuit 700, so that the first relay voltage Vb is added by n's step value (B2/A1). The number n of the step is a positive integer (n=1, 2, 3, 4, etc.). Wherein, the step value (B2/A1) is substantially equal to a third ratio value RT3, which is a quotient of the step value B2 divided by the scaling value A1. The total voltage gain G of the power conversion device 1000 is shown in equation (2-2), and the total voltage gain G decreases.

$$G = \frac{V o}{V i + ( \frac{B 2}{A 1} \times n )} = \frac{V o}{( \frac{V b}{2} ) + ( \frac{B 2}{A 1} \times n )} \qquad ( 2 - 2 )$$

On the other hand, please refer to FIG. 5B-2, the implementation condition is changed as: the sensing current Is was reduced by the scaling value A1, which means that the output load of the power conversion device 1010 is reduced by the scaling value A1. The first control circuit 700 simulates the addition operation of the first relay voltage Vb, such that n's step value (B2/A1) are added to the first relay voltage Vb. The total voltage gain G of the power conversion device 1000 is still as equation (2-2), and the total voltage gain G decreases.

Next, please refer to FIG. 5C-1. The implementation condition is: the sensing current Is decreases with the scaling A1, which means that the output load of the power conversion device 1010 decreases with the scaling A1. The first control circuit 700 simulates the division operation of the first relay voltage Vb, and accordingly controls the voltage converter 100 to adjust the first relay voltage Vb as: the first relay voltage Vb is divided by the scaling value (B1/A1). According to the above embodiment, the total voltage gain G is adjusted as equation (2-3). In response to a decrease of the output load by the scaling value A1, the first relay voltage Vb decreases by the scaling value (B1/A1), and the total voltage gain G increases.

$$G = \frac{V o}{V i / ( \frac{B 1}{A 1} )} = \frac{V o}{( \frac{V b}{2} ) / ( \frac{B 1}{A 1} )} \qquad ( 2 - 3 )$$

On the other hand, please refer to FIG. 5C-2, the implementation condition is changed as: the sensing current Is increases with the scaling value A1, which means that, the output load of the power conversion device 1010 increases with the scaling value A1. The first control circuit 700 simulates the division operation of the first relay voltage Vb, such that the first relay voltage Vb is divided by the scaling value (B1/A1). The total voltage gain G of the power conversion device 1000 is still as equation (2-3), and the total voltage gain G increases.

Next, please refer to FIG. 5D-1. The implementation condition is: the sensing current Is decreases with the scaling value A1, which means that the output load of the power conversion device 1010 decreases by the scaling value A1. The first control circuit 700 simulates the subtraction operation of the first relay voltage Vb, and subtracts n's step value (B2/A1) from the first relay voltage Vb. According to the above embodiment, the total voltage gain G is adjusted as equation (2-4). In response to the output load decreasing by the scaling value A1, the first relay voltage Vb decreases based on the step value (B2/A1), and the total voltage gain G increases.

$$G = \frac{V o}{V i - ( \frac{B 2}{A 1} \times n )} = \frac{V o}{( \frac{V b}{2} ) - ( \frac{B 2}{A 1} \times n )} \qquad ( 2 - 4 )$$

On the other hand, please refer to FIG. 5D-2, the implementation condition is changed as: the sensing current Is increases with the scaling value A1, which means that, the output load of the power conversion device 1010 increases with the scaling value A1. The first control circuit 700 simulates the subtraction operation of the first relay voltage Vb, and subtracts n's step value (B2/A1) from the first relay voltage Vb. The total voltage gain G of the power conversion device 1000 is still as equation (2-4), and the total voltage gain G increases.

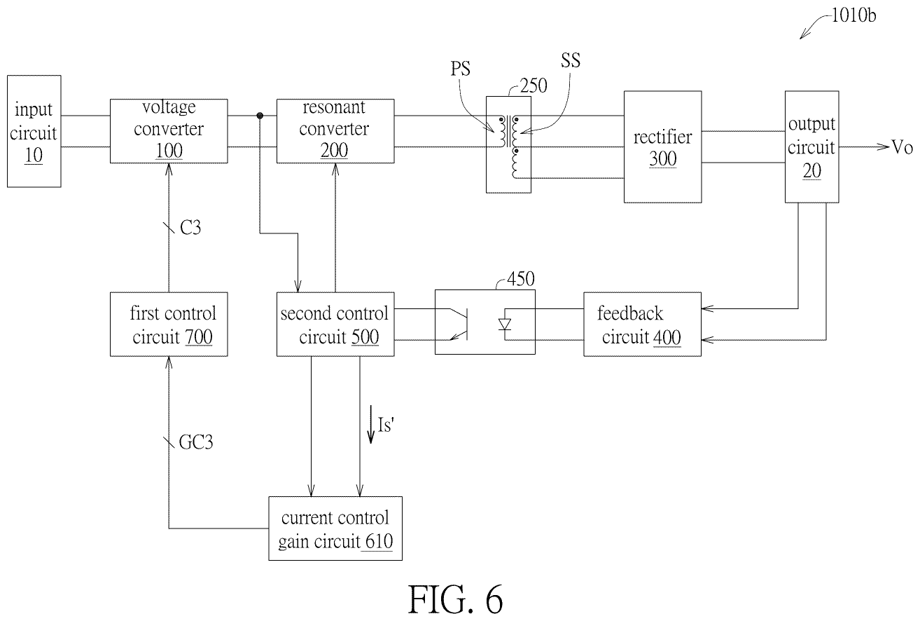

FIG. 6 is a circuit diagram of a power conversion device 1010b according to further another embodiment of the present disclosure. The operation mechanism of the power conversion device 1010b in FIG. 6 is similar to the power conversion device 1010 in FIG. 4, both of which execute control mechanisms based on the sensing currents of different load conditions. Compared with the power conversion device 1010 in FIG. 4 that senses the output load (the sensing current Is was generated by the current sensing circuit 350 between the rectifier 300 and the output circuit 20), the power conversion device 1010b in FIG. 6 performs sensing on the primary side load.

More specifically, the power conversion device 1010b in FIG. 6 does not need to dispose the current sensing circuit 350 in FIG. 4, but directly senses the sensing current Is generated by the second control circuit 500, through the current control gain circuit 610. The second control circuit 500 is coupled to the primary side PS of the transformer 250 via the resonant converter 200. Therefore, the sensing current Is′ generated by the second control circuit 500 is associated with the primary side PS. The sensing current Is′ can represent the primary side load of the power conversion device. 1010. The current control gain circuit 610 can analyze changes in the primary side load of the power conversion device 1010 according to the sensed current Is′.

Furthermore, the current control gain circuit 610 generates a corresponding gain control signal GC3 according to the change of the primary side load. The first control circuit 700 simulates the operations of multiplication/addition/division/subtraction of FIGS. 5A-1 to 5D-2 according to the gain control signal GC3. Furthermore, the first control circuit 700 generates a corresponding control signal C3 to control the voltage converter 100 to adjust the first relay voltage Vb (according to the operations of multiplication/addition/division/subtraction), thereby adjusting the total voltage gain G of the power conversion device 1010b.

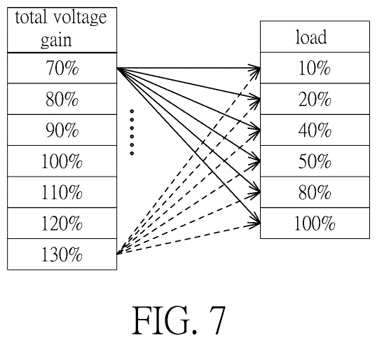

In another example, the current control gain circuit 610 may implement a control mechanism in a digital manner, so as to adjust the first relay voltage Vb and the total voltage gain G. For example, the current control gain circuit 610 is a digital circuit, and the current control gain circuit 610 has a built-in lookup table (or the current control gain circuit 610 can access a lookup table stored in other memory devices). The lookup table records relationships (referred to as “correspondences”) between the load and the total voltage gain G of the power conversion device 1010b The current control gain circuit 610 operates with reference to the correspondences in the lookup table. In response to different load conditions, the current control gain circuit 610 obtains the total voltage gain G corresponding to the present load obtained from the lookup table. The current control gain circuit 610 digitally implements a control mechanism to adjust the first relay voltage Vb and the total voltage gain G, according to a lookup table. The control mechanism is explained below with reference to FIG. 7.

FIG. 7 is a schematic diagram of a lookup table which is referenced by the current control gain circuit 610 of FIG. 6. As shown in FIG. 7, when the total voltage gain G of the power conversion device 1010b is 70%, it may correspond to one of the loads of 10%, 20%, . . . , 100%. The sensing current Is′ may represent the load of the power conversion device 1010b (for example, the primary side load). The current control gain circuit 610 monitors the sensing current Is′ to obtain the present value of the load of the power conversion device 1010b. Furthermore, the current control gain circuit 610 may obtain a corresponding value of the total voltage gain G, based on one of the correspondences between the voltage total gain G and the load which are recorded in the lookup table in FIG. 7.

For example, the current control gain circuit 610 monitors the sensing current Is′ to obtain that the present value of the load is 10%. According to the correspondences in the lookup table in FIG. 7, when the load value is 10%, it maps to the corresponding value of 70% of the total voltage gain G. Accordingly, the current control gain circuit 610 generates the corresponding gain control signal GC3, and the first control circuit 700 generates the corresponding control signal C3 according to the gain control signal GC3, so as to control the voltage converter 100. Furthermore, the voltage converter 100 adjusts the first relay voltage Vb based on the operations of multiplication/addition/division/subtraction, thereby adjusting the total voltage gain G to 70%.

In summary, the voltage control gain circuit 600 in the embodiment of FIG. 1 and the current control gain circuit 610 in the embodiments of FIGS. 4 and 6, can be referred to as a “control gain circuit”. The control gain circuit executes a control mechanism in response to the output differential voltage (Vo1, Vo2) or the sensing current Is of the power conversion device according to different load conditions (including load conditions of the output load or the primary side load), thereby adjusting the output voltage Vo and/or the first relay voltage Vb, thereby adjusting the total voltage gain G of the power conversion device. In other words, the control gain circuit can adjust the output voltage Vo according to the feedback of voltage (e.g., output differential voltage (Vo1, Vo2)) or current (e.g., sensing current Is), and can adjust the total voltage gain G accordingly. Accordingly, it can be ensured that, the output voltage Vo and the total voltage gain G of the power conversion device under different load conditions can meet specifications required by the user.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A power conversion device, comprising:
a voltage converter, for receiving an input differential voltage, wherein the input differential voltage is associated with an input voltage of the power conversion device, and the voltage converter converts the input differential voltage into a first relay voltage;
a resonant converter, for converting the first relay voltage into a second relay voltage;
a feedback circuit, receiving an output differential voltage, wherein the output differential voltage is indirectly associated with the second relay voltage, and the feedback circuit is coupled to the resonant converter through a feedback path;
an output circuit, for generating an output voltage of the power conversion device according to the output differential voltage; and
a control gain circuit, executing a control mechanism to adjust the first relay voltage and the output voltage,
wherein, the power conversion device has a total voltage gain, the total voltage gain is associated with a first ratio value of the output voltage and the input voltage, and the control gain circuit adjusts the total voltage gain according to the control mechanism.

2. The power conversion device of claim 1, wherein the voltage converter performs a power factor correction, a boost operation or a buck operation for the input differential voltage.

3. The power conversion device of claim 1, wherein the resonant converter is an inductor-inductor-capacitor (LLC) converter for executing a soft switching mechanism.

4. The power conversion device of claim 1, further comprising:
a first control circuit, for controlling the voltage converter in response to a gain control signal generated by the control gain circuit, so as to make the voltage converter adjust the first relay voltage.

5. The power conversion device of claim 4, further comprising:
a second control circuit, disposed on the feedback path, and controlling the resonant converter in response to a monitoring result generated by the feedback circuit and the first relay voltage, so as to make the resonant converter adjust the second relay voltage,
wherein, the second control circuit generates a pulse width modulation (PWM) signal in response to the monitoring result and the first relay voltage, and controls the resonant converter through the PWM signal.

6. The power conversion device of claim 5, wherein the first control circuit and the second control circuit are integrated into a control unit.

7. The power conversion device of claim 5, further comprising:
a coupling circuit, disposed between the feedback circuit and the second control circuit,
wherein, the feedback circuit is coupled to the resonant converter through the coupling circuit and the second control circuit, and the feedback circuit feeds back the monitoring result to the second control circuit through the coupling circuit.

8. The power conversion device of claim 5, wherein the second control circuit is coupled to an over-temperature protection circuit, and the second control circuit comprising:
an over-current protection circuit; and
an over-voltage protection circuit.

9. The power conversion device of claim 1, wherein the power conversion device is coupled to an external control device, and the external control device monitors the output differential voltage and generates a gain control signal, and performs a multiplication operation, a division operation, an addition operation or a subtraction operation to adjust the first relay voltage and the output voltage based on the gain control signal.

10. The power conversion device of claim 1, wherein the control gain circuit is a voltage control gain circuit which adjusts the first relay voltage, the output voltage and the total voltage gain in response to the output differential voltage.

11. The power conversion device of claim 10, wherein the voltage control gain circuit adjusts the first relay voltage and the output voltage based on a multiplication operation or a division operation.

12. The power conversion device of claim 11, wherein the voltage control gain circuit multiplies or divides the first relay voltage by a first scaling value, and multiplies or divides the output voltage by at a second scaling value.

13. The power conversion device of claim 10, wherein the voltage control gain circuit adjusts the first relay voltage and the output voltage according to an addition operation or a subtraction operation.

14. The power conversion device of claim 13, wherein the voltage control gain circuit adds or subtracts the first relay voltage by at least one first step value, and adds or subtracts the output voltage by at least one second step value.

15. The power conversion device of claim 5, wherein the control gain circuit is a current control gain circuit which adjusts the first relay voltage and the total voltage gain in response to a sensing current.

16. The power conversion device of claim 15, further comprising:
a transformer, having a primary side and a secondary side, wherein the primary side is coupled to the resonant converter, and the transformer converts the second relay voltage into a third relay voltage; and
a rectifier, coupled to the secondary side of the transformer, and the rectifier generates the output differential voltage according to the third relay voltage,
wherein, the second control circuit is coupled to the secondary side of the transformer through the resonant converter, and the feedback circuit is coupled to two output terminals of the rectifier to receive the output differential voltage.

17. The power conversion device of claim 16, wherein the rectifier is a diode rectifier or a synchronous rectifier.

18. The power conversion device of claim 16, wherein the sensing current is associated with the primary side of the transformer, and the sensing current represents a primary side load of the power conversion device.

19. The power conversion device of claim 18, wherein the sensing current is generated by the second control circuit, and the current control gain circuit directly receives and senses the sensing current from the second control circuit.

20. The power conversion device of claim 16, further comprising:
a current sensing circuit, disposed between the rectifier and the output circuit, the current sensing circuit generates the sensing current according to the output differential voltage, and the sensing current represents an output load of the power conversion device.

21. The power conversion device of claim 15, wherein the current control gain circuit adjusts the first relay voltage and the total voltage gain in a digital manner according to a lookup table,
wherein, the lookup table comprises a plurality of correspondences between the total voltage gain and a load of the power conversion device.

22. The power conversion device of claim 21, wherein the current control gain circuit monitors the sensing current to obtain a present value of the load, and obtains a corresponding value of the total voltage gain based on one of the correspondences between the total voltage gain and the load.

23. The power conversion device of claim 15, wherein the current control gain circuit adjusts the first relay voltage according to a multiplication operation or a division operation.

24. The power conversion device of claim 23, wherein the current control gain circuit multiplies or divides the first relay voltage by a second ratio value in response to a change of the sensing current with a first scaling value, the second ratio value is a quotient of a second scaling value divided by the first scaling value.

25. The power conversion device of claim 15, wherein the current control gain circuit adjusts the first relay voltage according to an addition operation or a subtraction operation.
